(19) United States
(12) Patent Application Publication
(10) Pub. No.: US 2020/0097774 A1
(43) Pub. Date: Mar. 26, 2020

(54) Apparatus and Method for Providing an Electronic User Manual

(71) Applicant: Solera Holdings, Inc., Westlake, TX (US)

(72) Inventors: Pascal Stucki, Zürich (CH); Manuel Stucki, Zürich (CH); Rocio Sanchez Ruiz, Madrid (ES)

(21) Appl. No.: 16/576,953

(22) Filed: Sep. 20, 2019

Related U.S. Application Data
(60) Provisional application No. 62/734,789, filed on Sep. 21, 2018.

(51) Int. Cl. G06K 9/62; G06T 7/70

(52) U.S. Cl. CPC G06K 9/6267; G06T 2200/24; G06T 7/70

(57) ABSTRACT

A method includes accessing an image captured by a camera and identifying a user object within the captured image. The method further includes determining a vehicle or consumer product associated with the captured image and accessing stored data associated with the determined vehicle or consumer product. The method further includes determining, using the stored data and the identified user object, information about the identified user object. The method further includes displaying the information about the identified user object.

### PRIORITY

This application claims the benefit, under 35 U.S.C. § 119(e), of U.S. Provisional Patent Application No. 62/734,789 filed 21 Sep. 2018, which is incorporated herein by reference.

### TECHNICAL FIELD

The disclosure generally relates generally to image processing, and more particularly to an apparatus and method for providing an electronic user manual.

### BACKGROUND

Vehicles such as automobiles and trucks contain many switches and warning lamps to both alert the driver of problems with their vehicle and to provide the user with the ability to control various aspects of their vehicle. Similarly, most consumer devices such as microwaves and refrigerators have switches, buttons, and indicator lights for the consumer to view and operate. However, users often do not understand the meaning or function of many buttons and indicator lights of vehicles and consumer devices.

### SUMMARY OF PARTICULAR EMBODIMENTS

In some embodiments, an apparatus includes one or more computer processors, a camera, and one or more memory units communicatively coupled to the one or more computer processors. The one or more memory units include instructions executable by the one or more computer processors. The one or more computer processors are operable when executing the instructions to access an image captured by the camera, identify a user object within the captured image, and determine a vehicle or consumer product associated with the captured image. The one or more computer processors are further operable when executing the instructions to access stored data associated with the determined vehicle or consumer product, determine, using the stored data and the identified user object, information about the identified user object, and display the determined information about the identified user object.

In some embodiments, a method includes accessing an image captured by a camera and identifying a user object within the captured image. The method further includes determining a vehicle or consumer product associated with the captured image and accessing stored data associated with the determined vehicle or consumer product. The method further includes determining, using the stored data and the identified user object, information about the identified user object. The method further includes displaying the information about the identified user object.

In some embodiments, one or more computer-readable non-transitory storage media includes one or more units of software that are operable when executed to access an image captured by the camera, identify a user object within the captured image, and determine a vehicle or consumer product associated with the captured image. The one or more units of software are further operable when executed to access stored data associated with the determined vehicle or consumer product, determine, using the stored data and the identified user object, information about the identified user object, and display the determined information about the identified user object.

An apparatus and method for providing an electronic user manual is described herein. Using the example of an automobile, the driver can scan selected switches and warning lamps in the vehicle using, for example, an app running on a smartphone. The app automatically identifies the switch or warning lamp and then obtains explanations on functions and, where relevant, recommendations for action. The app may then display the explanation or the recommendation for action related to the scanned switch or warning lamp in text form. In some embodiments, the explanation or the recommendation for action related to the scanned switch or warning lamp may be read out loud using the language function.

Other technical features may be readily apparent to person having ordinary skill in the art (PHOSITA) from the following figures, descriptions, and claims.

### BRIEF DESCRIPTION OF THE DRAWINGS

For a more complete understanding of this disclosure and its features, reference is now made to the following description, taken in conjunction with the accompanying drawings, in which:

FIG. 1 illustrates an example network environment associated with an apparatus and method for providing an electronic user manual;

FIGS. 2A-B illustrate an example personal computing device;

FIG. 3 illustrates an example software architecture for information and applications on a personal computing device;

FIG. 4 illustrates an example computer system;

FIGS. 5A-5H illustrate an example mobile application for providing an electronic user manual; and

FIGS. 6-7 illustrate example methods of providing an electronic user manual.

### DESCRIPTION OF EXAMPLE EMBODIMENTS

Vehicles such as automobiles and trucks contain many switches and warning lamps to both alert the driver of problems with their vehicle and to provide the user with the ability to control various functions of their vehicle. Similarly, most consumer devices such as microwaves and refrigerators have switches, buttons, and indicator lights for the consumer to view and operate. Most vehicles and consumer devices include printed user manuals that explain the functions of user objects such as switches, buttons, and indicator lights. However, it is not always easy or practical for users to access a printed user manual. For example, a driver of a truck may not be able to easily reference a printed user manual while driving in order to determine the meaning of a flashing indicator light on their dashboard.

To address these and other issues, the embodiments of the disclosure provide apparatuses, systems, and methods for providing an electronic user manual. In one particular example embodiment, an application running on a user device such as a smartphone enables a user to quickly snap a photo of a user object such as a switch, button, or indicator light of a vehicle or a consumer device. The application analyzes the photo in order to determine the user object and then display information about the user object. As a specific example, a driver of a vehicle may use an application running on their smartphone to snap a photo of a flashing indicator light on their dashboard. The application may analyze the photo in order to determine an identity of the indicator light and then display information about the indicator light (e.g., from the vehicle's user manual). As a result, the driver may be able to continue to safely operate the vehicle while obtaining critical information about their vehicle.

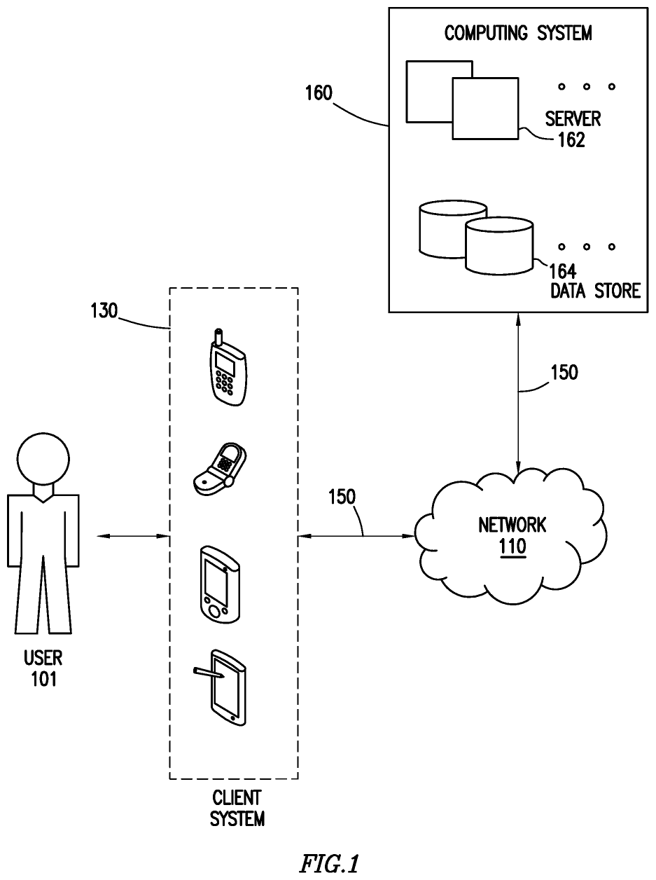

FIG. 1 illustrates an example network environment 100 associated with providing an electronic user manual. Network environment 100 includes a user 101, a client system 130, a computing system 160, and a third-party system 170 connected to each other by a network 110. Although FIG. 1 illustrates a particular arrangement of client system 130, computing system 160, third-party system 170, and network 110, this disclosure contemplates any suitable arrangement of client system 130, computing system 160, third-party system 170, and network 110. As an example and not by way of limitation, two or more of client system 130, computing system 160, and third-party system 170 may be connected to each other directly, bypassing network 110. As another example, two or more of client system 130, computing system 160, and third-party system 170 may be physically or logically co-located with each other in whole or in part. Moreover, although FIG. 1 illustrates a particular number of client systems 130, computing systems 160, third-party systems 170, and networks 110, this disclosure contemplates any suitable number of client systems 130, computing systems 160, third-party systems 170, and networks 110. As an example and not by way of limitation, network environment 100 may include multiple client system 130, computing systems 160, third-party systems 170, and networks 110.

This disclosure contemplates any suitable network 110. As an example and not by way of limitation, one or more portions of network 110 may include an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the Public Switched Telephone Network (PSTN), a cellular telephone network, or a combination of two or more of these. Network 110 may include one or more networks 110.

Links 150 may connect client system 130, computing system 160, and third-party system 170 to communication network 110 or to each other. This disclosure contemplates any suitable links 150. In particular embodiments, one or more links 150 include one or more wireline (such as for example Digital Subscriber Line (DSL) or Data Over Cable Service Interface Specification (DOCSIS)), wireless (such as for example Wi-Fi or Worldwide Interoperability for Microwave Access (WiMAX)), or optical (such as for example Synchronous Optical Network (SONET) or Synchronous Digital Hierarchy (SDH)) links. In particular embodiments, one or more links 150 each include an ad hoc network, an intranet, an extranet, a VPN, a LAN, a WLAN, a WAN, a WWAN, a MAN, a portion of the Internet, a portion of the PSTN, a cellular technology-based network, a satellite communications technology-based network, another link 150, or a combination of two or more such links 150. Links 150 need not necessarily be the same throughout network environment 100. One or more first links 150 may differ in one or more respects from one or more second links 150.

In particular embodiments, client system 130 may be an electronic device including hardware, software, or embedded logic components or a combination of two or more such components and capable of carrying out the appropriate functionalities implemented or supported by client system 130. As an example and not by way of limitation, a client system 130 may include a computer system (e.g., computer system 400) such as a desktop computer, notebook or laptop computer, netbook, a tablet computer, e-book reader, GPS device, camera, personal digital assistant (PDA), handheld electronic device, cellular telephone, smartphone, augmented/virtual reality device, other suitable electronic device, or any suitable combination thereof. This disclosure contemplates any suitable client systems 130. A client system 130 may enable a network user at client system 130 to access network 110. A client system 130 may enable its user to communicate with other users at other client systems 130.

In particular embodiments, client system 130 may include a web browser 132, such as MICROSOFT INTERNET EXPLORER, GOOGLE CHROME or MOZILLA FIREFOX, and may have one or more add-ons, plug-ins, or other extensions, such as TOOLBAR or YAHOO TOOLBAR. A user at client system 130 may enter a Uniform Resource Locator (URL) or other address directing the web browser 132 to a particular server (such as server 162, or a server associated with a third-party system 170), and the web browser 132 may generate a Hyper Text Transfer Protocol (HTTP) request and communicate the HTTP request to server. The server may accept the HTTP request and communicate to client system 130 one or more Hyper Text Markup Language (HTML) files responsive to the HTTP request. Client system 130 may render a webpage based on the HTML files from the server for presentation to the user. This disclosure contemplates any suitable webpage files. As an example and not by way of limitation, webpages may render from HTML files, Extensible Hyper Text Markup Language (XHTML) files, or Extensible Markup Language (XML) files, according to particular needs. Such pages may also execute scripts such as, for example and without limitation, those written in JAVASCRIPT, JAVA, MICROSOFT SILVERLIGHT, combinations of markup language and scripts such as AJAX (Asynchronous JAVASCRIPT and XML), and the like. Herein, reference to a webpage encompasses one or more corresponding webpage files (which a browser may use to render the webpage) and vice versa, where appropriate.

In particular embodiments, computing system 160 may be a network-addressable computing system. Computing system 160 may generate, store, receive, and send data. Computing system 160 may be accessed by the other components of network environment 100 either directly or via network 110. As an example and not by way of limitation, client system 130 may access computing system 160 using a web browser 132, or a native application associated with computing system 160 (e.g., a mobile application) either directly or via network 110. In particular embodiments, computing system 160 may include one or more servers 162. Each server 162 may be a unitary server or a distributed server spanning multiple computers or multiple datacenters. Servers 162 may be of various types, such as, for example and without limitation, web server, news server, mail server, message server, file server, application server, exchange server, database server, proxy server, another server suitable for performing functions or processes described herein, or any combination thereof. In particular embodiments, each server 162 may include hardware, software, or embedded logic components or a combination of two or more such components for carrying out the appropriate functionalities implemented or supported by server 162. In particular embodiments, computing system 160 may include one or more data stores 164. Data stores 164 may be used to store various types of information. In particular embodiments, the information stored in data stores 164 may be organized according to specific data structures. In particular embodiments, each data store 164 may be a relational, columnar, correlation, or other suitable database. Although this disclosure describes or illustrates particular types of databases, this disclosure contemplates any suitable types of databases. Particular embodiments may provide interfaces that enable a client system 130, a computing system 160, or a third-party system 170 to manage, retrieve, modify, add, or delete, the information stored in data store 164.

In particular embodiments, computing system 160 may be capable of linking a variety of entities. As an example and not by way of limitation, computing system 160 may enable users to interact with each other as well as receive content from third-party systems 170 or other entities, or to allow users to interact with these entities through an application programming interfaces (API) or other communication channels.

In particular embodiments, a third-party system 170 may include one or more types of servers, one or more data stores, one or more interfaces, including but not limited to APIs, one or more web services, one or more content sources, one or more networks, or any other suitable components, e.g., that servers may communicate with. A third-party system 170 may be operated by a different entity from an entity operating computing system 160.

In particular embodiments, computing system 160 may include a variety of servers, sub-systems, programs, modules, logs, and data stores. In particular embodiments, computing system 160 may include one or more of the following: a web server, action logger, API-request server, notification controller, action log, third-party-content-object-exposure log, inference module, authorization/privacy server, search module, user-interface module, user-profile store, connection store, third-party content store, or location store. Computing system 160 may also include suitable components such as network interfaces, security mechanisms, load balancers, failover servers, management-and-network-operations consoles, other suitable components, or any suitable combination thereof. In particular embodiments, computing system 160 may include one or more user-profile stores for storing user profiles. A user profile may include, for example, biographic information, demographic information, behavioral information, social information, or other types of descriptive information. A web server may be used for linking computing system 160 to one or more client systems 130 or one or more third-party system 170 via network 110. The web server may include a mail server or other messaging functionality for receiving and routing messages between computing system 160 and one or more client systems 130. An API-request server may allow a third-party system 170 to access information from computing system 160 by calling one or more APIs. An action logger may be used to receive communications from a web server about a user's actions on or off computing system 160. In conjunction with the action log, a third-party-content-object log may be maintained of user exposures to third-party-content objects. A notification controller may provide information regarding content objects to a client system 130. Information may be pushed to a client system 130 as notifications, or information may be pulled from client system 130 responsive to a request received from client system 130. Authorization servers may be used to enforce one or more privacy settings of the users of computing system 160. A privacy setting of a user determines how particular information associated with a user can be shared. The authorization server may allow users to opt in to or opt out of having their actions logged by computing system 160 or shared with other systems (e.g., third-party system 170), such as, for example, by setting appropriate privacy settings. Third-party-content-object stores may be used to store content objects received from third parties, such as a third-party system 170. Location stores may be used for storing location information received from client systems 130 associated with users.

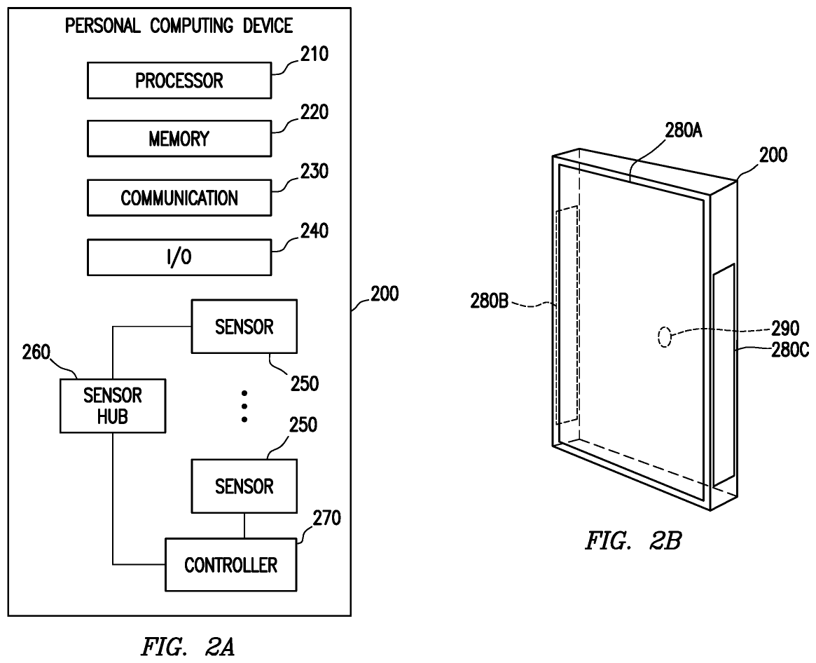

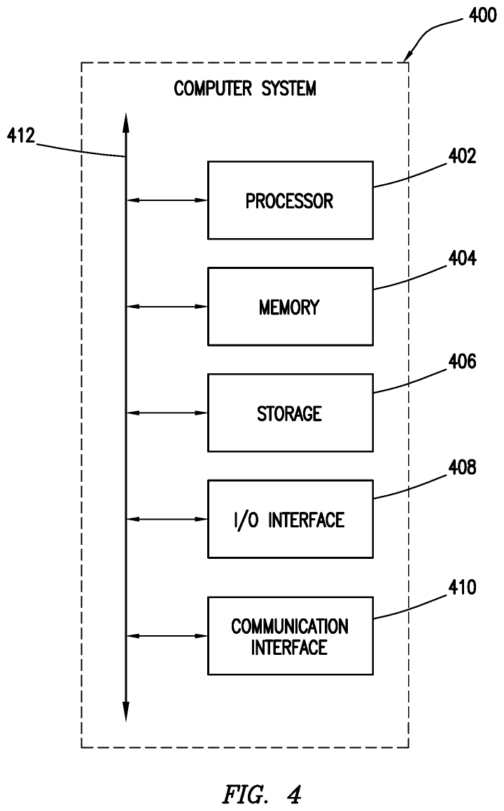

FIG. 2A illustrates an example personal computing device 200. In particular embodiments, personal computing device 200 includes a processor 210, a memory 220, a communication component 230 (e.g., antenna and communication interface for wireless communications), one or more input and/or output (I/O) components and/or interfaces 240, and one or more sensors 250. In particular embodiments, one or more I/O components and/or interfaces 240 may incorporate one or more sensors 250. In particular embodiments, personal computing device 200 may comprise a computer system or an element thereof as described in FIG. 4 and associated description.

In particular embodiments, personal computing device 200, such as a mobile device, may include various types of sensors 250, such as, for example and without limitation: touch sensors (disposed, for example, on a display of the device, the back of the device and/or one or more lateral edges of the device) for detecting a user touching the surface of the mobile electronic device (e.g., using one or more fingers); accelerometer for detecting whether the personal computing device 200 is moving and the speed of the movement; thermometer for measuring the temperature change near the personal computing device 200; proximity sensor for detecting the proximity of the personal computing device 200 to another object (e.g., a hand, desk, or other object); light sensor for measuring the ambient light around the personal computing device 200; imaging sensor (e.g., camera) for capturing digital still images and/or video of objects near the personal computing device 200 (e.g., scenes, people, bar codes, QR codes, etc.); location sensors (e.g., Global Positioning System (GPS)) for determining the location (e.g., in terms of latitude and longitude) of the mobile electronic device; sensors for detecting communication networks within close proximity (e.g., near field communication (NFC), Bluetooth, RFID, infrared); chemical sensors; biometric sensors for biometrics-based (e.g., fingerprint, palm vein pattern, hand geometry, iris/retina, DNA, face, voice, olfactory, sweat) authentication of user of personal computing device 200; etc. This disclosure contemplates that a mobile electronic device may include any applicable type of sensor. Sensors may provide various types of sensor data, which may be analyzed to determine the user's intention with respect to the mobile electronic device at a given time.

In particular embodiments, a sensors hub 260 may optionally be included in personal computing device 200. Sensors 250 may be connected to sensors hub 260, which may be a low power-consuming processor that controls sensors 250, manages power for sensors 250, processes sensor inputs, aggregates sensor data, and performs certain sensor functions. In addition, in particular embodiments, some types of sensors 250 may be connected to a controller 270. In this case, sensors hub 260 may be connected to controller 270, which in turn is connected to sensor 250. Alternatively, in particular embodiments, there may be a sensor monitor in place of sensors hub 260 for managing sensors 250.

In particular embodiments, in addition to the front side, personal computing device 200 may have one or more sensors for performing biometric identification. Such sensors may be positioned on any surface of personal computing device 200. In example embodiments, as the user's hand touches personal computing device 200 to grab hold of it, the touch sensors may capture the user's fingerprints or palm vein pattern. In example embodiments, while a user is viewing the screen of personal computing device 200, a camera may capture an image of the user's face to perform facial recognition. In example embodiments, while a user is viewing the screen of personal computing device 200, an infrared scanner may scan the user's iris and/or retina. In example embodiments, while a user is in contact or close proximity with personal computing device 200, chemical and/or olfactory sensors may capture relevant data about a user. In particular embodiments, upon detecting that there is a change in state with respect to the identity of the user utilizing personal computing device 200, either by itself or in combination with other types of sensor indications, personal computing device 200 may determine that it is being shared.

In particular embodiments, in addition to the front side, the personal computing device 200 may have touch sensors on the left and right sides. Optionally, the personal computing device 200 may also have touch sensors on the back, top, or bottom side. Thus, as the user's hand touches personal computing device 200 to grab hold of it, the touch sensors may detect the user's fingers or palm touching personal computing device 200. In particular embodiments, upon detecting that there is a change in state with respect to a user touching personal computing device 200, either by itself or in combination with other types of sensor indications, personal computing device 200 may determine that it is being shared.

In particular embodiments, personal computing device 200 may have an accelerometer in addition to or instead of the touch sensors on the left and right sides. Sensor data provided by the accelerometer may also be used to estimate whether a new user has picked up personal computing device 200 from a resting position, e.g., on a table or desk, display shelf, or from someone's hand or from within someone's bag. When the user picks up personal computing device 200 and brings it in front of the user's face, there may be a relatively sudden increase in the movement speed of personal computing device 200. This change in the device's movement speed may be detected based on the sensor data supplied by the accelerometer. In particular embodiments, upon detecting that there is a significant increase in the speed of the device's movement, either by itself or in combination with other types of sensor indications, personal computing device 200 may determine that it is being shared.

In particular embodiments, personal computing device 200 may have a Gyrometer in addition or instead of the touch sensors on the left and right sides. A Gyrometer, also known as a gyroscope, is a device for measuring the orientation along one or more axis. In particular embodiments, a Gyrometer may be used to measure the orientation of personal computing device 200. When personal computing device 200 is stored on a shelf or in the user's bag, it may stay mostly in one orientation. However, when the user grabs hold of personal computing device 200 and lifts it up and/or moves it closer to bring it in front of the user's face, there may be a relatively sudden change in the orientation of personal computing device 200. The orientation of personal computing device 200 may be detected and measured by the gyrometer. If the orientation of personal computing device 200 has changed significantly, In particular embodiments, upon detecting that there is a significant change in the orientation of personal computing device 200, either by itself or in combination with other types of sensor indications, personal computing device 200 may determine that it is being shared.

In particular embodiments, personal computing device 200 may have a light sensor. When personal computing device 200 is stored in a user's pocket or case, it is relatively dark around personal computing device 200. On the other hand, when the user brings personal computing device 200 out of his pocket, it may be relatively bright around personal computing device 200, especially during day time or in well-lit areas. The sensor data supplied by the light sensor may be analyzed to detect when a significant change in the ambient light level around personal computing device 200 occurs. In particular embodiments, upon detecting that there is a significant increase in the ambient light level around personal computing device 200, either by itself or in combination with other types of sensor indications, personal computing device 200 may determine that it is being shared.

In particular embodiments, personal computing device 200 may have a proximity sensor. The sensor data supplied by the proximity sensor may be analyzed to detect when personal computing device 200 is in close proximity to a specific object, such as the user's hand. For example, mobile device 200 may have an infrared LED (light-emitting diode) 290 (i.e., proximity sensor) placed on its back side. When the user holds such a mobile device in his hand, the palm of the user's hand may cover infrared LED 290. As a result, infrared LED 290 may detect when the user's hand is in close proximity to mobile device 200. In particular embodiments, upon detecting that personal computing device 200 is in close proximity to the user's hand, either by itself or in combination with other types of sensor indications, personal computing device 200 may determine that it is being shared.

A personal computing device 200 may have any number of sensors of various types, and these sensors may supply different types of sensor data. Different combinations of the individual types of sensor data may be used together to detect and estimate a user's current intention with respect to personal computing device 200 (e.g., whether the user really means to take personal computing device 200 out of his pocket and use it). Sometimes, using multiple types of sensor data in combination may yield a more accurate, and thus better, estimation of the user's intention with respect to personal computing device 200 at a given time than only using a single type of sensor data. Nevertheless, it is possible to estimate the user's intention using a single type of sensor data (e.g., touch-sensor data).

FIG. 2B illustrates the exterior of an example personal computing device 200. Personal computing device 200 has approximately six sides: front, back, top, bottom, left, and right. Touch sensors may be placed anywhere on any of the six sides of personal computing device 200. For example, in FIG. 2B, a touchscreen incorporating touch sensors 280A is placed on the front of personal computing device 200. The touchscreen may function as an input/output (I/O) component for personal computing device 200. In addition, touch sensors 280B and 280C are placed on the left and right sides of personal computing device 200, respectively. Touch sensors 280B and 280C may detect a user's hand touching the sides of personal computing device 200. In particular embodiments, touch sensors 280A, 280B, 280C may be implemented using resistive, capacitive, and/or inductive touch sensors. The electrodes of the touch sensors 280A, 280B, 280C may be arranged on a thin solid piece of material or a thin wire mesh. In the case of capacitive touch sensors, there may be two types of electrodes: transmitting and receiving. These electrodes may be connected to a controller (e.g., controller 270 illustrated in FIG. 2A), which may be a microchip designed to drive the transmitting electrodes with electrical pulses and measure the changes in capacitance from the receiving electrodes caused by a user's touches in order to detect the locations of the user touches.

Of course, personal computing device 200 is merely an example. In practice, a device may have any number of sides, and this disclosure contemplates devices with any number of sides. The touch sensors may be placed on any side of a device.

In particular embodiments, personal computing device 200 may have a proximity sensor 290 (e.g., an infrared LED) placed on its back side. Proximity sensor 290 may be able to supply sensor data for determining its proximity, and thus the proximity of personal computing device 200, to another object.

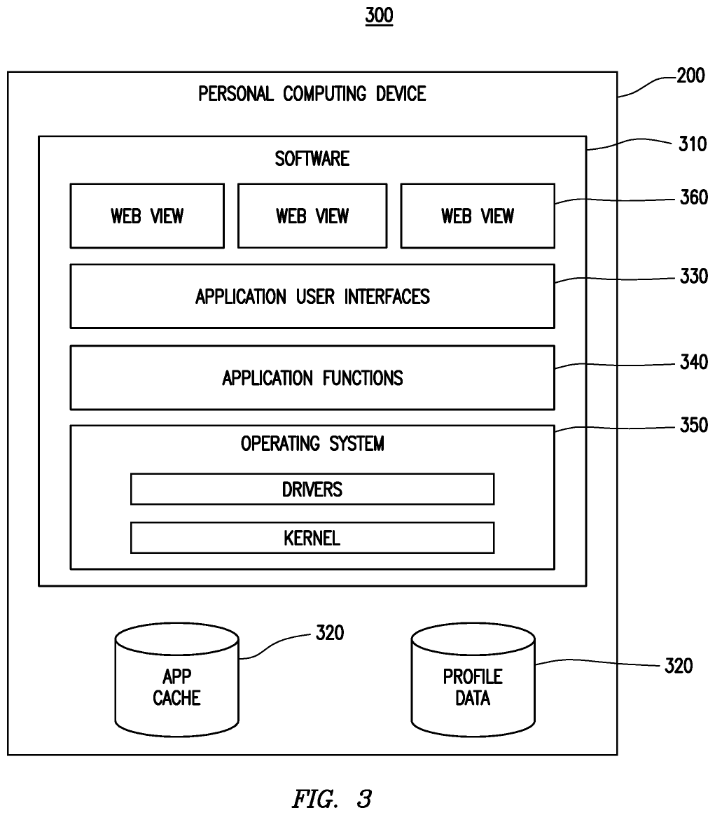

FIG. 3 illustrates an example software architecture 300 for information and applications on personal computing device 200. In particular embodiments, software architecture 300 includes software 310 and data store(s) 320. In particular embodiments, personal information may be stored in an application data cache 320 and/or a profile data store 320 and/or another data store 320. In particular embodiments, one or more software applications may be executed on personal computing device 200. In particular embodiments, they may be web-based applications hosted on servers. For example, a web-based application may be associated with a URI (Uniform Resource Identifier) or URL (Uniform Resource Locator). From personal computing device 200, a user may access the web-based application through its associated URI or URL (e.g., by using a web browser). Alternatively, in other embodiments, they may be native applications installed and residing on personal computing device 200. Thus, software 310 may also include any number of application user interfaces 330 and application functions 340. For example, one application (e.g., Google Maps®) may enable a device user to view a map, search for addresses and businesses, and get directions; a second application may enable the device user to read, send, and receive emails; a third application (e.g., a web browser) may enable the device user to browse and search the Internet; a fourth application may enable the device user to take photos or record videos using personal computing device 200; a fifth application may allow the device user to receive and initiate VoIP and/or cellular network calls, and so on. Each application has one or more specific functionalities, and the software (e.g., one or more software modules) implementing these functionalities may be included in application functions 340. Each application may also have a user interface that enables the device user to interact with the application, and the software implementing the application user interface may be included in application user interfaces 330. In particular embodiments, the functionalities of an application may be implemented using JavaScript®, Java®, C, or other suitable programming languages. In particular embodiments, the user interface of an application may be implemented using HyperText Markup Language (HTML), JavaScript®, Java®, or other suitable programming languages.

In particular embodiments, the user interface of an application may include any number of screens or displays. In particular embodiments, each screen or display of the user interface may be implemented as a web page. Thus, the device user may interact with the application through a series of screens or displays (i.e., a series of web pages). In particular embodiments, operating system 350 is Google's Android™ mobile technology platform. With Android®, there is a Java® package called “android.webkit”, which provides various tools for browsing the web. Among the “android.webkit” package, there is a Java class called “android.webkit.WebView”, which implements a View for displaying web pages. This class uses the WebKit rendering engine to display web pages and includes methods to navigate forward and backward through a history, zoom in, zoom out, perform text searches, and so on. In particular embodiments, an application user interface 330 may utilize Android's WebView API to display each web page of the user interface in a View implemented by the “android.webkit.WebView” class. Thus, in particular embodiments, software 310 may include any number of web views 360, each for displaying one or more web pages that implement the user interface of an application.

During the execution of an application, the device user may interact with the application through its user interface. For example, the user may provide inputs to the application in various displays (e.g., web pages). Outputs of the application may be presented to the user in various displays (e.g., web pages) as well. In particular embodiments, when the user provides an input to the application through a specific display (e.g., a specific web page), an event (e.g., an input event) may be generated by, for example, a web view 360 or application user interfaces 330. Each input event may be forwarded to application functions 340, or application functions 340 may listen for input events thus generated. When application functions 340 receive an input event, the appropriate software module in application functions 340 may be invoked to process the event. In addition, specific functionalities provided by operating system 350 and/or hardware (e.g., as described in FIGS. 3A-B) may also be invoked. For example, if the event is generated as a result of the user pushing a button to take a photo with personal computing device 200, a corresponding image processing module may be invoked to convert the raw image data into an image file (e.g., JPG or GIF) and store the image file in the storage 320 of personal computing device 200. As anther example, if the event is generated as a result of the user selecting an icon to compose an instant message, the corresponding short message service (SMS) module may be invoked to enable the user to compose and send the message.

In particular embodiments, when an output of the application is ready to be presented to the user, an event (e.g., an output event) may be generated by, for example, a software module in application functions 340 or operating system 350. Each output event may be forwarded to application user interfaces 330, or application user interfaces 330 may listen for output events thus generated. When application user interfaces 330 receive an output event, it may construct a web view 360 to display a web page representing or containing the output. For example, in response to the user selecting an icon to compose an instant message, an output may be constructed that includes a text field that allows the user to input the message. This output may be presented to the user as a web page and displayed to the user in a web view 360 so that the user may type into the text field the message to be sent.

The user interface of an application may be implemented using a suitable programming language (e.g., HTML, JavaScript®, or Java®). More specifically, in particular embodiments, each web page that implements a screen or display of the user interface may be implemented using a suitable programming language. In particular embodiments, when a web view 360 is constructed to display a web page (e.g., by application user interfaces 330 in response to an output event), the code implementing the web page is loaded into web view 360.

FIG. 4 illustrates an example computer system 400. In particular embodiments, one or more computer systems 400 perform one or more steps of one or more methods described or illustrated herein. In particular embodiments, one or more computer systems 400 provide functionality described or illustrated herein. In particular embodiments, software running on one or more computer systems 400 performs one or more steps of one or more methods described or illustrated herein or provides functionality described or illustrated herein. Particular embodiments include one or more portions of one or more computer systems 400. Herein, reference to a computer system may encompass a computing device, and vice versa, where appropriate. Moreover, reference to a computer system may encompass one or more computer systems, where appropriate.

This disclosure contemplates any suitable number of computer systems 400. This disclosure contemplates computer system 400 taking any suitable physical form. As example and not by way of limitation, computer system 400 may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, a tablet computer system, an augmented/virtual reality device, or a combination of two or more of these. Where appropriate, computer system 400 may include one or more computer systems 400; be unitary or distributed; span multiple locations; span multiple machines; span multiple data centers; or reside in a cloud, which may include one or more cloud components in one or more networks. Where appropriate, one or more computer systems 400 may perform without substantial spatial or temporal limitation one or more steps of one or more methods described or illustrated herein. As an example and not by way of limitation, one or more computer systems 400 may perform in real time or in batch mode one or more steps of one or more methods described or illustrated herein. One or more computer systems 400 may perform at different times or at different locations one or more steps of one or more methods described or illustrated herein, where appropriate.

In particular embodiments, computer system 400 includes a processor 402, memory 404, storage 406, an input/output (I/O) interface 408, a communication interface 410, and a bus 412. Although this disclosure describes and illustrates a particular computer system having a particular number of particular components in a particular arrangement, this disclosure contemplates any suitable computer system having any suitable number of any suitable components in any suitable arrangement.

In particular embodiments, processor 402 includes hardware for executing instructions, such as those making up a computer program. As an example and not by way of limitation, to execute instructions, processor 402 may retrieve (or fetch) the instructions from an internal register, an internal cache, memory 404, or storage 406; decode and execute them; and then write one or more results to an internal register, an internal cache, memory 404, or storage 406. In particular embodiments, processor 402 may include one or more internal caches for data, instructions, or addresses. This disclosure contemplates processor 402 including any suitable number of any suitable internal caches, where appropriate. As an example and not by way of limitation, processor 402 may include one or more instruction caches, one or more data caches, and one or more translation lookaside buffers (TLBs). Instructions in the instruction caches may be copies of instructions in memory 404 or storage 406, and the instruction caches may speed up retrieval of those instructions by processor 402. Data in the data caches may be copies of data in memory 404 or storage 406 for instructions executing at processor 402 to operate on; the results of previous instructions executed at processor 402 for access by subsequent instructions executing at processor 402 or for writing to memory 404 or storage 406; or other suitable data. The data caches may speed up read or write operations by processor 402. The TLBs may speed up virtual-address translation for processor 402. In particular embodiments, processor 402 may include one or more internal registers for data, instructions, or addresses. This disclosure contemplates processor 402 including any suitable number of any suitable internal registers, where appropriate. Where appropriate, processor 402 may include one or more arithmetic logic units (ALUs); be a multi-core processor; or include one or more processors 402. Although this disclosure describes and illustrates a particular processor, this disclosure contemplates any suitable processor.

In particular embodiments, memory 404 includes main memory for storing instructions for processor 402 to execute or data for processor 402 to operate on. As an example and not by way of limitation, computer system 400 may load instructions from storage 406 or another source (such as, for example, another computer system 400) to memory 404. Processor 402 may then load the instructions from memory 404 to an internal register or internal cache. To execute the instructions, processor 402 may retrieve the instructions from the internal register or internal cache and decode them. During or after execution of the instructions, processor 402 may write one or more results (which may be intermediate or final results) to the internal register or internal cache. Processor 402 may then write one or more of those results to memory 404. In particular embodiments, processor 402 executes only instructions in one or more internal registers or internal caches or in memory 404 (as opposed to storage 406 or elsewhere) and operates only on data in one or more internal registers or internal caches or in memory 404 (as opposed to storage 406 or elsewhere). One or more memory buses (which may each include an address bus and a data bus) may couple processor 402 to memory 404. Bus 412 may include one or more memory buses, as described below. In particular embodiments, one or more memory management units (MMUs) reside between processor 402 and memory 404 and facilitate accesses to memory 404 requested by processor 402. In particular embodiments, memory 404 includes random access memory (RAM). This RAM may be volatile memory, where appropriate Where appropriate, this RAM may be dynamic RAM (DRAM) or static RAM (SRAM). Moreover, where appropriate, this RAM may be single-ported or multi-ported RAM. This disclosure contemplates any suitable RAM. Memory 404 may include one or more memories 404, where appropriate. Although this disclosure describes and illustrates particular memory, this disclosure contemplates any suitable memory.

In particular embodiments, storage 406 includes mass storage for data or instructions. As an example and not by way of limitation, storage 406 may include a hard disk drive (HDD), a floppy disk drive, flash memory, an optical disc, a magneto-optical disc, magnetic tape, or a Universal Serial Bus (USB) drive or a combination of two or more of these. Storage 406 may include removable or non-removable (or fixed) media, where appropriate. Storage 406 may be internal or external to computer system 400, where appropriate. In particular embodiments, storage 406 is non-volatile, solid-state memory. In particular embodiments, storage 406 includes read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these. This disclosure contemplates mass storage 406 taking any suitable physical form. Storage 406 may include one or more storage control units facilitating communication between processor 402 and storage 406, where appropriate. Where appropriate, storage 406 may include one or more storages 406. Although this disclosure describes and illustrates particular storage, this disclosure contemplates any suitable storage.

In particular embodiments, I/O interface 408 includes hardware, software, or both, providing one or more interfaces for communication between computer system 400 and one or more I/O devices. Computer system 400 may include one or more of these I/O devices, where appropriate. One or more of these I/O devices may enable communication between a person and computer system 400. As an example and not by way of limitation, an I/O device may include a keyboard, keypad, microphone, monitor, mouse, printer, scanner, speaker, still camera, stylus, tablet, touch screen, trackball, video camera, another suitable I/O device or a combination of two or more of these. An I/O device may include one or more sensors. This disclosure contemplates any suitable I/O devices and any suitable I/O interfaces 408 for them. Where appropriate, I/O interface 408 may include one or more device or software drivers enabling processor 402 to drive one or more of these I/O devices. I/O interface 408 may include one or more I/O interfaces 408, where appropriate. Although this disclosure describes and illustrates a particular I/O interface, this disclosure contemplates any suitable I/O interface.

In particular embodiments, communication interface 410 includes hardware, software, or both providing one or more interfaces for communication (such as, for example, packet-based communication) between computer system 400 and one or more other computer systems 400 or one or more networks. As an example and not by way of limitation, communication interface 410 may include a network interface controller (NIC) or network adapter for communicating with an Ethernet or other wire-based network or a wireless NIC (WNIC) or wireless adapter for communicating with a wireless network, such as a WI-FI network. This disclosure contemplates any suitable network and any suitable communication interface 410 for it. As an example and not by way of limitation, computer system 400 may communicate with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, computer system 400 may communicate with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination of two or more of these. Computer system 400 may include any suitable communication interface 410 for any of these networks, where appropriate. Communication interface 410 may include one or more communication interfaces 410, where appropriate. Although this disclosure describes and illustrates a particular communication interface, this disclosure contemplates any suitable communication interface.

In particular embodiments, bus 412 includes hardware, software, or both coupling components of computer system 400 to each other. As an example and not by way of limitation, bus 412 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination of two or more of these. Bus 412 may include one or more buses 412, where appropriate. Although this disclosure describes and illustrates a particular bus, this disclosure contemplates any suitable bus or interconnect.

Herein, a computer-readable non-transitory storage medium or media may include one or more semiconductor-based or other integrated circuits (ICs) (such, as for example, field-programmable gate arrays (FPGAs) or application-specific ICs (ASICs)), hard disk drives (HDDs), hybrid hard drives (HHDs), optical discs, optical disc drives (ODDs), magneto-optical discs, magneto-optical drives, floppy diskettes, floppy disk drives (FDDs), magnetic tapes, solid-state drives (SSDs), RAM-drives, SECURE DIGITAL cards or drives, any other suitable computer-readable non-transitory storage media, or any suitable combination of two or more of these, where appropriate. A computer-readable non-transitory storage medium may be volatile, non-volatile, or a combination of volatile and non-volatile, where appropriate.

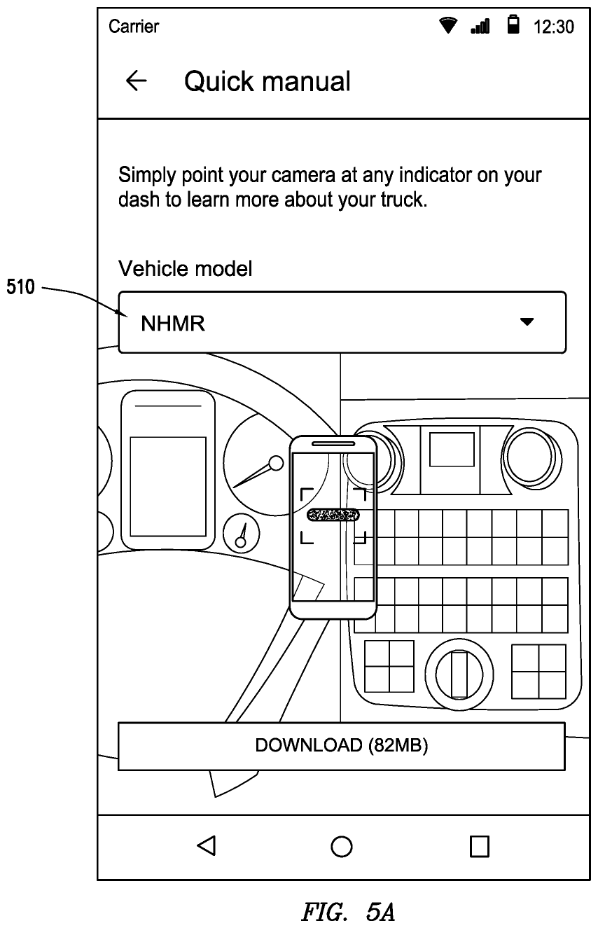

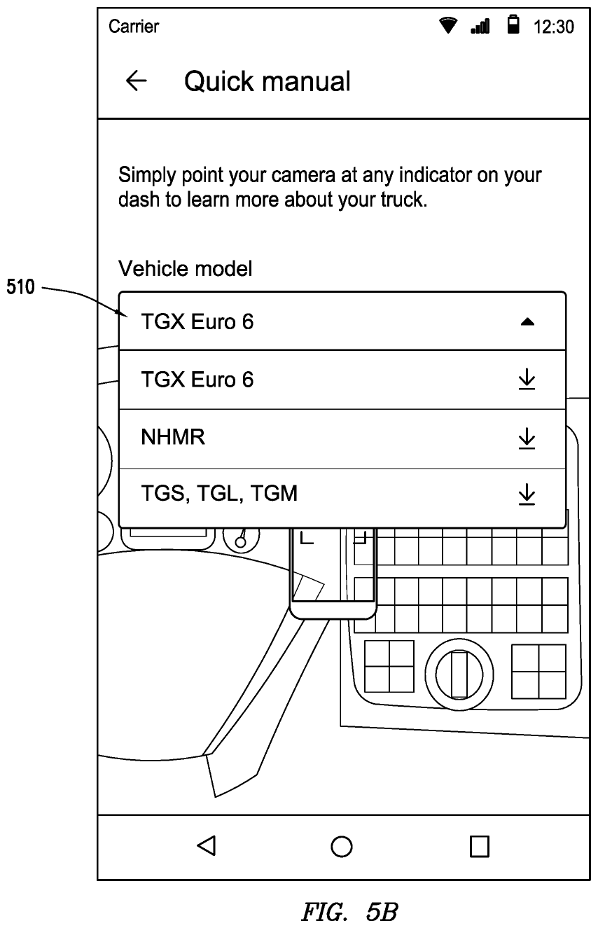

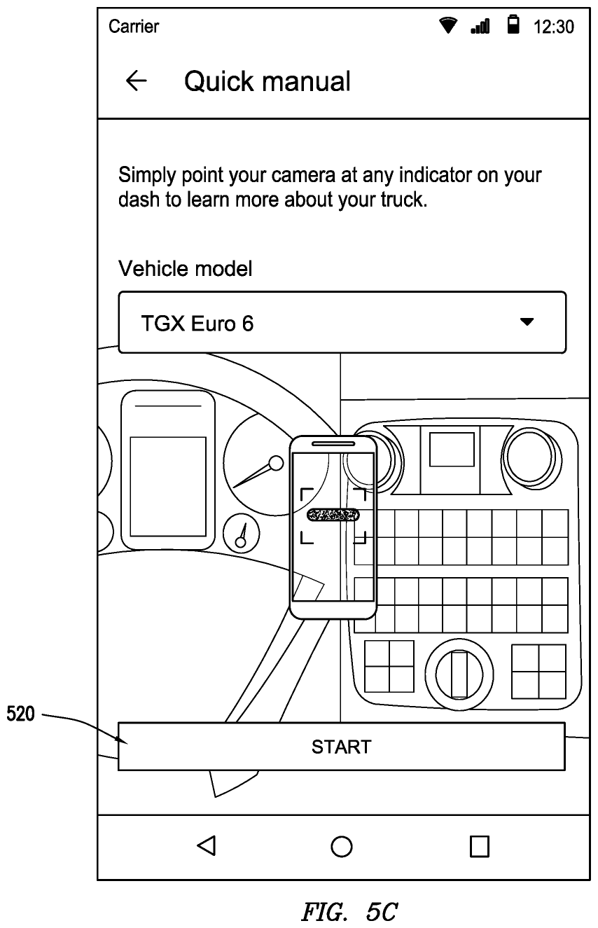

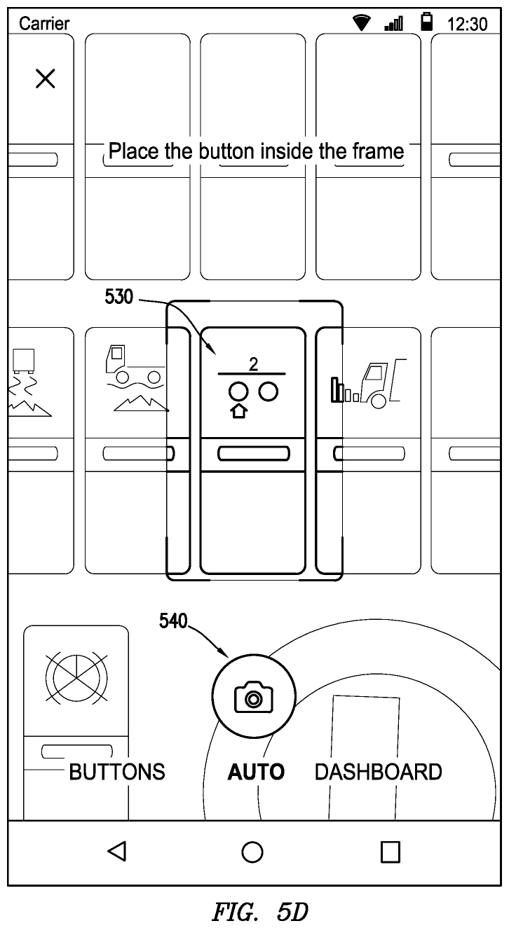

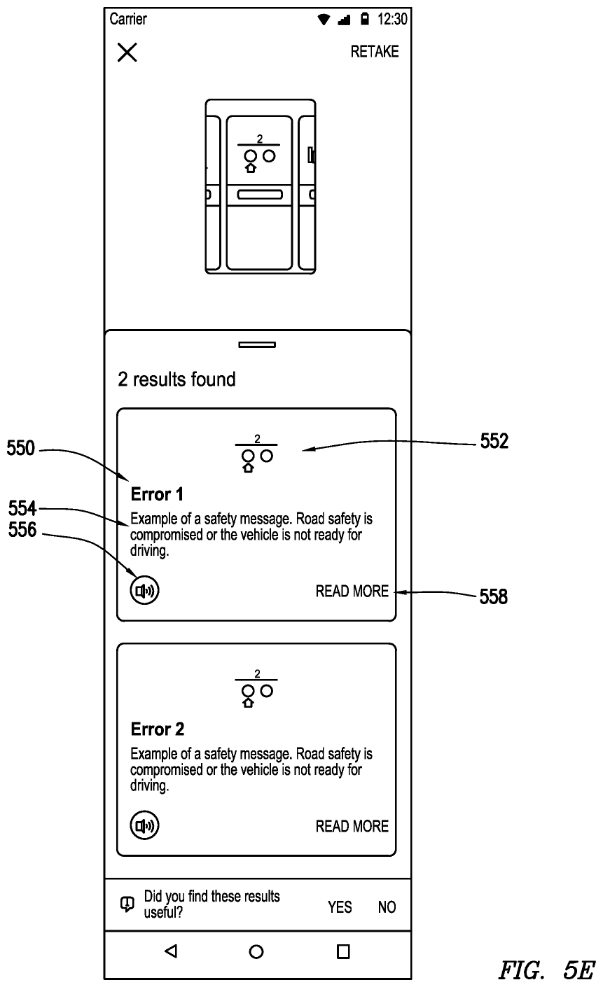

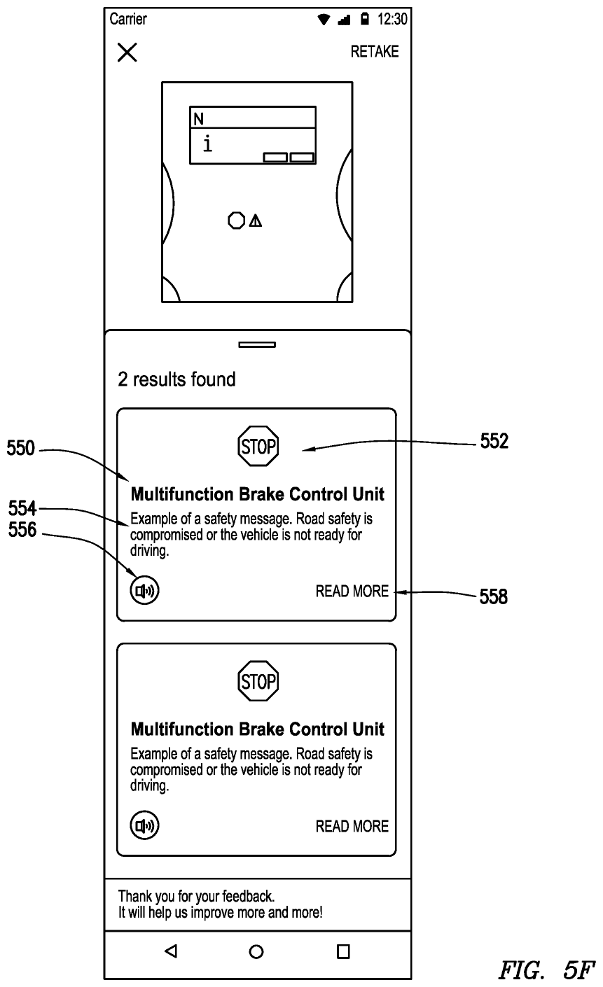

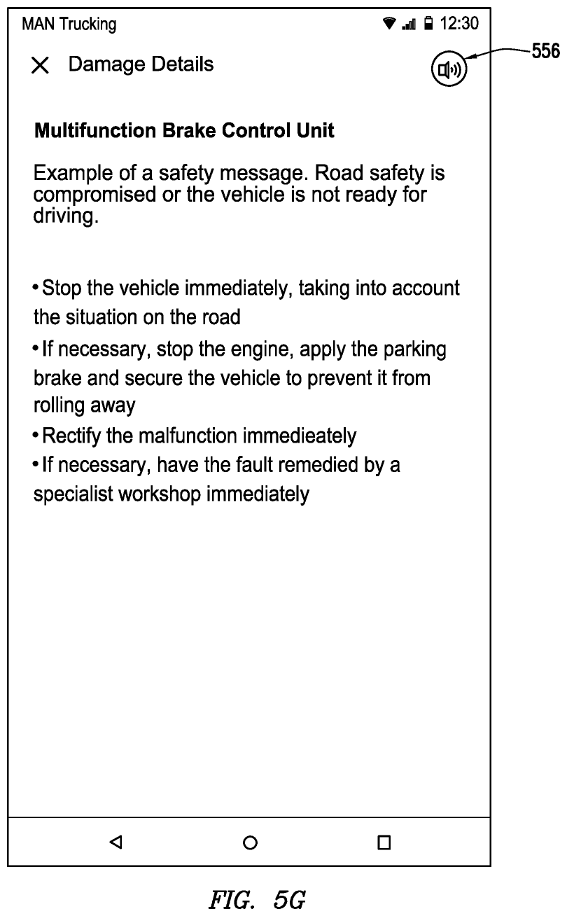

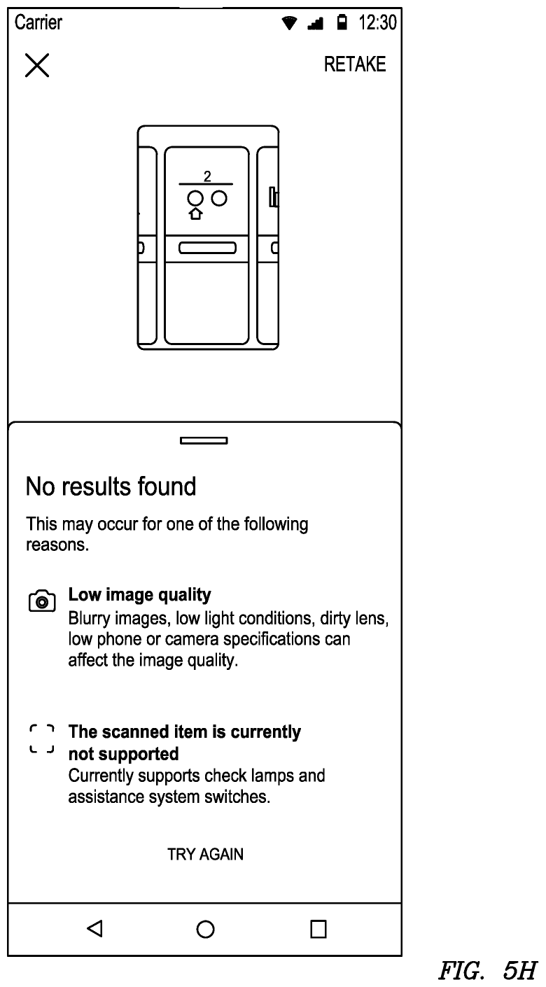

FIGS. 5A-5H illustrate screenshots of an example mobile application for providing an electronic user manual. In general, the Quick Manual (“QM”) application illustrated in FIGS. 5A-5H allows a user to utilize their smartphone camera (or other user device) to detect a user object and then provide information from a user manual about the user object. Using the example of a vehicle, a driver may utilize the QM application to capture an image of an indicator light on their vehicle's dashboard or a button that operates a function of the vehicle. The QM application analyses the captured image and compares it to known user objects from, for example, the vehicle's owner's or operator's manual. Once the QM application identifies the user object, it displays a description of the object and/or relevant chapter from the manual. For example, the QM application may display a description about what occurs if a particular button of a vehicle is pressed. As another example, the QM application may display information about the meaning of a warning light. In some embodiments, a phone's native text-to-speech function may be utilized to read the relevant text from the user manual out loud. In some embodiments, on-board diagnostics (OBD) information (e.g., error codes) may be used to help recognize and potentially resolve the issue.

FIGS. 5A-5C illustrate an example home screen of the example mobile application for providing an electronic user manual. In this example, the user may be provided with a user-selection area 510 that permits the user to enter or select a specific model or type of vehicle or consumer product. As a specific example, a user may select user-selection area 510 in FIG. 5A in order to be presented with a list of possible vehicles or consumer products as illustrated in FIG. 5B. The user may then select the appropriate vehicle or consumer product from the drop-down list. Once the appropriate vehicle or consumer product is selected or otherwise provided, the user may be presented with an option 520 as illustrated in FIG. 5C to “START” and proceed to the screen illustrated in FIG. 5D.

In FIG. 5D, the user is presented with a screen that instructs the user to point their user device (e.g., smartphone) at the desired user object (e.g., button or indicator lamp) in order to place the user object inside a designated area 530. Once the user object is within designated area 530, the user may press or otherwise choose a capture option 540 in order to take a photograph of the user object. In some embodiments, the application may automatically capture an image of the user object within designated area 530 without the user pressing capture option 540 if certain predetermined conditions are met (e.g., if the user device is motionless or almost motionless for at least a certain period of time).

In FIGS. 5E-5F, the example mobile application displays a “card” 550 about the captured user object. In some embodiments, card 550 may include a stock image 552 of the captured user object, a description 554 of the captured user object, a read-aloud option 556, and a “READ MORE” option 558. The user may select read-aloud option 556 to have the application read description 554 out loud to the user. This may enable, for example, a driver to keep their eyes on the road, thereby increasing safety. A user may select “READ MORE” option 558 to display additional information about the user object as illustrated in FIG. 5G.

FIG. 5H illustrates a screen that the application displays when it is unable to determine a user object from a captured image. In some embodiments, the application displays possible causes for the error (e.g., low image quality). In some embodiments, a “RETAKE” option may be provided that allows the user to attempt to capture another image of the user object (e.g., proceed back to the screen illustrated in FIG. 5D).

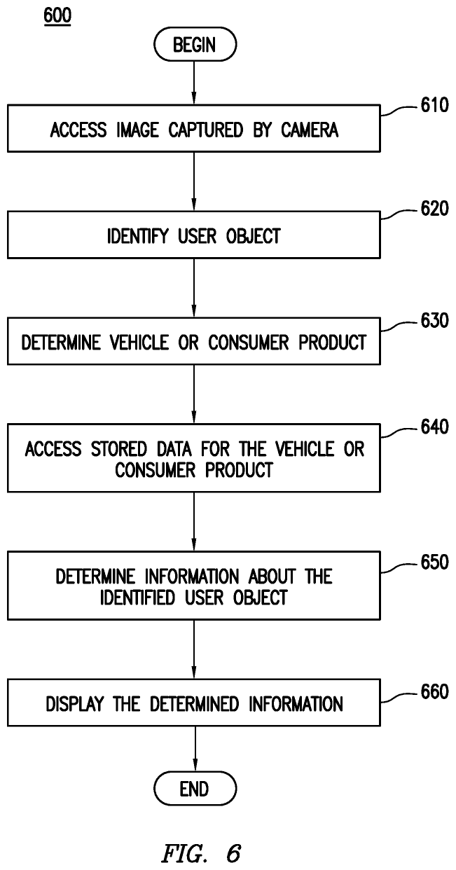

FIG. 6 illustrates an example method 600 of providing an electronic user manual, according to certain embodiments. In some embodiments, method 600 may be performed by a user device such as personal computing device 200 (e.g., a smartphone running an application). Method 600 may begin in step 610 where an image is accessed. In some embodiments, the image accessed in this step is from a camera such as a camera of personal computing device 200 described above. In some embodiments, the image is stored locally on personal computing device 200. In other embodiments, the image may be accessed from a remote computing system via a network.

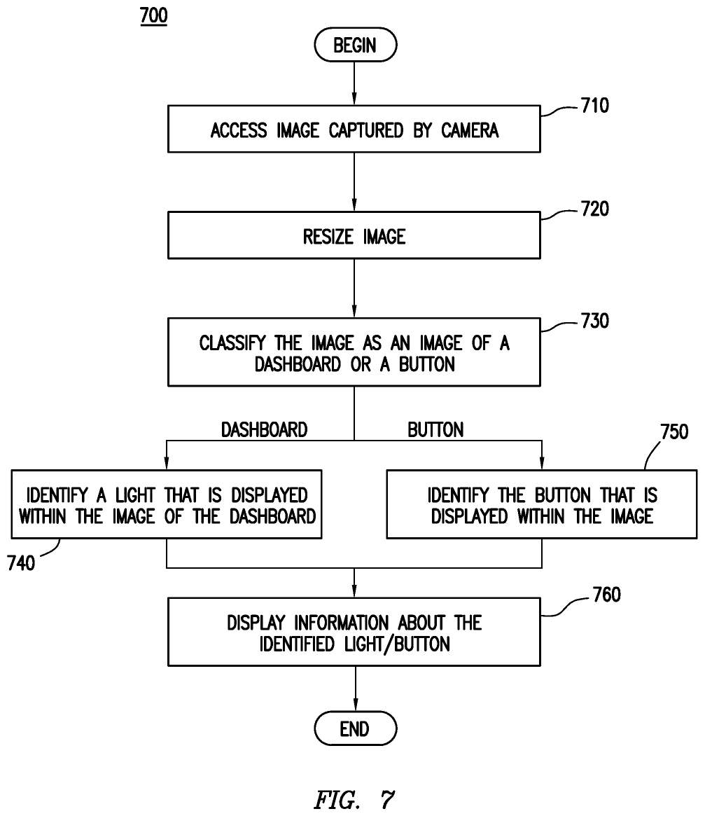

At step 620 method 600 identifies a user object in the image accessed in step 610. In some embodiments, the user object is a switch, button, or indicator light of a vehicle. The vehicle may be an automobile, a motorcycle, a truck, a recreational vehicle, a construction vehicle, an airplane, a helicopter, a boat, or any other vehicle. In some embodiments, the user object is a switch, button, or indicator light of a consumer product. For example, the consumer product may be an appliance (e.g., a refrigerator, oven, etc.). In some embodiments, step 620 includes utilizing object detection models as described in more detail below in reference to FIG. 7. For example, step 620 may include classifying, using an image classification process, the image of step 610 as either an image of a dashboard or an image of a button. If method 600 determines in step 620 that the image is an image of a dashboard, step 620 may identify the user object as a particular warning lamp by comparing the image to a plurality of stored models of warning lamps. If method 600 determines in step 620 that the image is an image of a button, step 620 may identify the user object as a particular button by comparing the image to a plurality of stored models of buttons. The models may be stored locally (e.g., on personal computing device 200) or may be accessed from a remote computing system via a network.

At step 630, method 600 determines a vehicle or consumer product associated with the captured image. In some embodiments, step 630 includes accessing a user-selection or identification of the particular vehicle or consumer product associated with the captured image. For example, the user may be presented with an option in a user interface in which to select or otherwise indicate a particular vehicle or consumer product associated with the captured image (e.g., a drop-down list of available vehicles). In other embodiments, step 630 may utilize other methods to determine a vehicle or consumer product associated with the captured image. As one example, step 630 may include accessing a unique identification of the vehicle (e.g., a vehicle identification number (VIN)) or a unique identification of the consumer product (e.g., a serial number). The unique identification number may be accessed from an image (e.g., a barcode), may be input by the user in a user interface, may be accessed from a user profile (stored locally or remotely) of the user, or any other appropriate manner. In some embodiments, step 630 may cross-reference the unique identification number with a database (stored locally or remotely) in order determine a particular vehicle or consumer product associated with the unique identification number.

At step 640, method 600 accesses stored data associated with the determined vehicle or consumer product. The data associated with the determined vehicle or consumer product may be stored locally (e.g., on personal computing device 200) or may be accessed from a remote computing system via a network. In some embodiments, the stored data associated with the determined vehicle or consumer product includes a user manual for the vehicle or consumer product in electronic format. In some embodiments, the stored data may be a database of user objects (e.g., images of switches, buttons, and indicator lights) and their associated descriptions.

At step 650, method 600 determines, using the stored data of step 640 and the identified user object of step 620, information about the identified user object. For example, step 650 may include cross-referencing a database or stored user manual in order to determine a description of an indicator light of a vehicle. As another example, step 650 may include cross-referencing a database or stored user manual in order to determine a description of the function of a button of a consumer device.

At step 660, method 600 displays the information about the identified user object of step 650. In some embodiments, the information about the identified user object includes an explanation regarding a function of the identified user object or a recommendation for action regarding the identified user object. In some embodiments, step 660 includes displaying one or more cards 550 as illustrated in FIGS. 5E-5F in a user interface. The one or more cards may include a stock image of the identified user object, a description of the identified user object, a read-aloud option, and a “READ MORE” option. After step 660, method 600 may end.

Particular embodiments may repeat one or more steps of the method of FIG. 6, where appropriate. Although this disclosure describes and illustrates particular steps of the method of FIG. 6 as occurring in a particular order, this disclosure contemplates any suitable steps of the method of FIG. 6 occurring in any suitable order. Moreover, although this disclosure describes and illustrates an example method for providing an electronic user manual including the particular steps of the method of FIG. 6, this disclosure contemplates any suitable method for providing an electronic user manual including any suitable steps, which may include all, some, or none of the steps of the method of FIG. 6, where appropriate. Furthermore, although this disclosure describes and illustrates particular components, devices, or systems carrying out particular steps of the method of FIG. 6, this disclosure contemplates any suitable combination of any suitable components, devices, or systems carrying out any suitable steps of the method of FIG. 6.

FIG. 7 illustrates an example method 700 of providing an electronic user manual, according to certain embodiments. In some embodiments, method 700 may be performed by a user device such as personal computing device 200 (e.g., a smartphone running an application). Method 700 may begin in step 710 where an image is accessed. In some embodiments, the image accessed in this step is from a camera such as a camera of personal computing device 200 described above. In some embodiments, the image is stored locally on personal computing device 200. In other embodiments, the image may be accessed from a remote computing system via a network.

At step 720, some embodiments of method 700 may resize the image of step 710. For example, the image may be resized to a smaller size such as 300×300 pixels. The resized image of step 720 may be stored locally on personal computing device 200 or on a remote computing system via a network.

At step 730, method 700 classifies the image of step 710 or 720. In some embodiments, step 730 includes classifying the image as either an image of a dashboard or an image of a button. For example, step 730 may automatically detect (e.g., in a few hundred milliseconds) if the input image contains a dashboard or a buttons panel. In other embodiments, step 730 may automatically detect if the input image contains a switch or other element of a vehicle or consumer electronic device. In some embodiments, this step includes utilizing stored machine learning models that are trained using images for each category (e.g., button, dashboard, switch, etc.). The models may be stored locally (e.g., on personal computing device 200) or may be accessed from a remote computing system via a network. The input image may be processed in this step by an image classifier that compares the input image to the stored models. The output of this step may be an indication of whether the image is an image of a dashboard or an image of a button (or other element of a vehicle or consumer electronic device). If method 700 determines in step 730 that the image is an image of a dashboard, method 700 may proceed to step 740. However, if method 700 determines in step 730 that the image is an image of a button, method 700 may proceed to step 750.

At step 740, method 700 identifies an indicator light that is displayed within the image of step 710 or 720. In some embodiments, step 740 includes identifying the indicator light using single shot multibox detection. In some embodiments, step 740 includes utilizing a transfer learning process on top of pre-trained object detection models of dashboards. The models used in step 740 may be stored locally (e.g., on personal computing device 200) or may be accessed from a remote computing system via a network.

At step 750, method 700 identifies a button that is displayed within the image of step 710 or 720. In some embodiments, step 750 includes identifying the button using single shot multibox detection. In some embodiments, step 750 includes utilizing a transfer learning process on top of pre-trained object detection models of buttons. The models used in step 750 may be stored locally (e.g., on personal computing device 200) or may be accessed from a remote computing system via a network.

At step 760, method 700 displays the information about the identified light or button of steps 740 or 750. In some embodiments, the information about the identified light or button includes an explanation regarding function of the identified button or a recommendation for action regarding the identified light. In some embodiments, step 760 includes displaying one or more cards 550 as illustrated in FIGS. 5E-5F in a user interface. The one or more cards may include a stock image of the identified user object, a description of the identified user object, a read-aloud option, and a “READ MORE” option. After step 760, method 700 may end.

Particular embodiments may repeat one or more steps of the method of FIG. 7, where appropriate. Although this disclosure describes and illustrates particular steps of the method of FIG. 7 as occurring in a particular order, this disclosure contemplates any suitable steps of the method of FIG. 7 occurring in any suitable order. Moreover, although this disclosure describes and illustrates an example method for providing an electronic user manual including the particular steps of the method of FIG. 7, this disclosure contemplates any suitable method for providing an electronic user manual including any suitable steps, which may include all, some, or none of the steps of the method of FIG. 7, where appropriate. Furthermore, although this disclosure describes and illustrates particular components, devices, or systems carrying out particular steps of the method of FIG. 7, this disclosure contemplates any suitable combination of any suitable components, devices, or systems carrying out any suitable steps of the method of FIG. 7.

The architecture and associated instructions/operations described in this document can provide various advantages over prior approaches, depending on the implementation. For example, this approach provides an electronic user manual is described herein. Using the example of an automobile, the driver can scan selected switches and warning lamps in the vehicle using, for example, an app running on a smartphone. The app automatically identifies the switch or warning lamp and then obtains explanations on functions and, where relevant, recommendations for action. The app may then display the explanation and/or the recommendation for action related to the scanned switch or warning lamp in text form. In some embodiments, the explanation and/or the recommendation for action related to the scanned switch or warning lamp may be read out loud using the language function. Moreover, this functionality can be used to improve other fields of computing, such as artificial intelligence, deep learning, and virtual reality.

In some embodiments, various functions described in this document are implemented or supported by a computer program that is formed from computer readable program code and that is embodied in a computer readable medium. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

It may be advantageous to set forth definitions of certain words and phrases used throughout this patent document. The terms “application” and “program” refer to one or more computer programs, software components, sets of instructions, procedures, functions, objects, classes, instances, related data, or a portion thereof adapted for implementation in a suitable computer code (including source code, object code, or executable code). The terms “communicate,” “transmit,” and “receive,” as well as derivatives thereof, encompasses both direct and indirect communication. The terms “include” and “comprise,” as well as derivatives thereof, mean inclusion without limitation. The term “or” is inclusive, meaning and/or. The phrase “associated with,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, have a relationship to or with, or the like. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and Band C.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other modifications may occur to those ordinarily skilled in the art.

Herein, a computer-readable non-transitory storage medium or media may include one or more semiconductor-based or other integrated circuits (ICs) (such, as for example, field-programmable gate arrays (FPGAs) or application-specific ICs (ASICs)), hard disk drives (HDDs), hybrid hard drives (HHDs), optical discs, optical disc drives (ODDs), magneto-optical discs, magneto-optical drives, floppy diskettes, floppy disk drives (FDDs), magnetic tapes, solid-state drives (SSDs), RAM-drives, SECURE DIGITAL cards or drives, any other suitable computer-readable non-transitory storage media, or any suitable combination of two or more of these, where appropriate. A computer-readable non-transitory storage medium may be volatile, non-volatile, or a combination of volatile and non-volatile, where appropriate.

1. An apparatus comprising:
one or more computer processors;
a camera; and
one or more memory units communicatively coupled to the one or more computer processors, the one or more memory units comprising instructions executable by the one or more computer processors, the one or more computer processors being operable when executing the instructions to:
access an image captured by the camera;
identify a user object within the captured image;
determine a vehicle or consumer product associated with the captured image;
access stored data associated with the determined vehicle or consumer product;
determine, using the stored data and the identified user object, information about the identified user object; and
display the determined information about the identified user object.

2. The apparatus of claim 1, wherein the user object is a switch, button, or indicator light.

3. The apparatus of claim 1, wherein the information about the identified user object comprises:
an explanation regarding function of the identified user object; or
a recommendation for action regarding the identified user object.

4. The apparatus of claim 1, wherein identifying the user object within the captured image comprises:
classifying, using an image classification process, the captured image as either an image of a dashboard or an image of a button;
when the captured image is classified as an image of a dashboard, identify the user object as a particular warning lamp by comparing the captured image to a plurality of stored models of warning lamps; and
when the captured image is classified as an image of a button, identify the user object as a particular button by comparing the captured image to a plurality of stored models of buttons.

5. The apparatus of claim 1, wherein the stored data associated with the determined vehicle or consumer product comprises an electronic user manual for the vehicle or consumer product.

6. The apparatus of claim 1, wherein the vehicle comprises an automobile, a motorcycle, a truck, a recreational vehicle, a construction vehicle, an airplane, or a helicopter.

7. A method, comprising:
accessing, by one or more computing systems, an image captured by a camera;
identifying, by the one or more computing systems, a user object within the captured image;
determining, by the one or more computing systems, a vehicle or consumer product associated with the captured image;
accessing, by the one or more computing systems, stored data associated with the determined vehicle or consumer product;
determining, by the one or more computing systems, using the stored data and the identified user object, information about the identified user object; and
displaying, by the one or more computing systems, the information about the identified user object.

8. The method of claim 7, wherein the user object is a switch, button, or indicator light.

9. The method of claim 7, wherein the information about the identified user object comprises:
an explanation regarding function of the identified user object; or
a recommendation for action regarding the identified user object.

10. The method of claim 7, wherein identifying the user object within the captured image comprises:
classifying, using an image classification process, the captured image as either an image of a dashboard or an image of a button;
when the captured image is classified as an image of a dashboard, identify the user object as a particular warning lamp by comparing the captured image to a plurality of stored models of warning lamps; and
when the captured image is classified as an image of a button, identify the user object as a particular button by comparing the captured image to a plurality of stored models of buttons.

11. The method of claim 7, wherein the stored data associated with the determined vehicle or consumer product comprises an electronic user manual for the vehicle or consumer product.

12. The method of claim 7, wherein the vehicle comprises an automobile, a motorcycle, a truck, a recreational vehicle, a construction vehicle, an airplane, or a helicopter.

13. The method of claim 7, wherein determining the vehicle or consumer product associated with the captured image comprises:
accessing a user-selection of the vehicle or consumer product; or
accessing a unique identification of the vehicle or consumer product.

14. One or more computer-readable non-transitory storage media embodying one or more units of software that are operable when executed to:
access an image captured by a camera;
identify a user object within the captured image;
determine a vehicle or consumer product associated with the captured image;
access stored data associated with the determined vehicle or consumer product;
determine, using the stored data and the identified user object, information about the identified user object; and
display the information about the identified user object.

15. The one or more computer-readable non-transitory storage media of claim 14, wherein the user object is a switch, button, or indicator light.

16. The one or more computer-readable non-transitory storage media of claim 14, wherein the information about the identified user object comprises:
an explanation regarding function of the identified user object; or
a recommendation for action regarding the identified user object.

17. The one or more computer-readable non-transitory storage media of claim 14, wherein identifying the user object within the captured image comprises:
classifying, using an image classification process, the captured image as either an image of a dashboard or an image of a button;
when the captured image is classified as an image of a dashboard, identify the user object as a particular warning lamp by comparing the captured image to a plurality of stored models of warning lamps; and
when the captured image is classified as an image of a button, identify the user object as a particular button by comparing the captured image to a plurality of stored models of buttons.

18. The one or more computer-readable non-transitory storage media of claim 14, wherein the stored data associated with the determined vehicle or consumer product comprises an electronic user manual for the vehicle or consumer product.

19. The one or more computer-readable non-transitory storage media of claim 14, wherein the vehicle comprises an automobile, a motorcycle, a truck, a recreational vehicle, a construction vehicle, an airplane, or a helicopter.

20. The one or more computer-readable non-transitory storage media of claim 14, wherein determining the vehicle or consumer product associated with the captured image comprises:
accessing a user-selection of the vehicle or consumer product; or
accessing a unique identification of the vehicle or consumer product.
